(19) United States
(12) Patent Application Publication
(10) Pub. No.: US 2022/0155445 A1
(43) Pub. Date: May 19, 2022

(54) MEASUREMENT SYSTEM FOR OPTICAL MEASUREMENT

(71) Applicant: MICRO-EPSILON OPTRONIC GMBH, Langebrueck (DE)

(72) Inventors: Lars TOBESCHAT, Dresden (DE); Christoph GRUEBER, Dresden (DE); Thomas WISSPEINTNER, Ortenburg (DE)

(21) Appl. No.: 17/435,598

(22) PCT Filed: Jan. 31, 2020
(86) PCT No.: PCT/DE2020/200011

§ 371 Date: Sep. 1, 2021

(30) Foreign Application Priority Data
Apr. 1, 2019 (DE) 10 2019 204 613.4

(51) Int. Cl. G01S 17/48; G01S 17/42; G01S 7/481

(52) U.S. Cl. CPC G01S 17/48; G01S 7/4813; G01S 17/42

(57) ABSTRACT

A measurement system for optical measurement, in particular for measuring distance and/or position and/or speed and/or colour, defines at least one outer fixing point, which defines an outer coordinate system or lies therein, and at least one inner fixing point, which defines an inner coordinate system or lies therein. The two coordinate systems have a unique position relative to one another, which implies an adjustment or calibration of the system.

### CROSS REFERENCE TO RELATED APPLICATIONS

This application is a national stage application, filed under 35 U. S.C. § 371, of International Application No. PCT/DE2020/200011, filed Jan. 31, 2020, which international application claims priority to and the benefit of German Application No. 10 2019 204 613.4, filed Apr. 1, 2019; the contents of both of which as are hereby incorporated by reference in their entireties.

### BACKGROUND

The invention relates to a measurement system for optical measurement, in particular for measuring distance and/or position and/or speed and/or color.

Measurement systems of the type discussed here are sufficiently known from practice. At issue here, generally speaking, is optical metrology with almost unlimited application possibilities. Suitable measurement systems determine the respective measured parameter of a measurement object from a reference plane without contact. The necessary illumination spot (point, line, any pattern such as stripe light or the like) of the optical transmission axis for determining the measured parameter is always located in a tolerance-afflicted truncated cone (position (x/y/z) and angle (α)), which is unambiguously assigned to the reference plane.

### BRIEF SUMMARY

Generally, a measurement system is provided for optical measurement, in particular for measuring at least one of distance, position, speed, or color. The measurement system comprises at least one external fixed point, which defines an external coordinate system or lies therein, and at least one internal fixed point, which defines an internal coordinate system or lies therein. The external and the internal coordinate systems each have, in certain embodiments, an unambiguous reproducible position relative to one another, which implies an adjustment or calibration of the system.

In certain embodiments, the external and the internal coordinate systems are identical. In other embodiments, the external and the internal coordinate systems can be converted into one another by means of at least one of translation, rotation, or mirroring. In at least one embodiment, the internal coordinate system defines the position of at least one of the optical components, the imaging components, or the image-recording components. In these and other embodiments, the internal coordinate system defines the position of the optical axis with respect to position and direction.

In certain embodiments, the external coordinate system is a mechanical reference coordinate system that has to be aligned with the coordinate system of the respective measurement application. In at least one embodiment, the imaging components comprise at least one optomechanical light source as transmitting optics. In these and other embodiments, the image-recording components comprise at least one optomechanical sensor element as receiving optics.

In certain embodiments, the position of the optomechanical components or the transmitting optics relative to the internal coordinate system can be set to predeterminable values. For example, the external and the internal fixed point are assigned to a monolithic structural element. The measurement system may also further comprise transmitting optics and receiving optics disposed on a monolithic structural element adjusted in accordance with the fixed points. In at least one embodiment, the transmitting optics and receiving optics are configured for laser triangulation.

In certain embodiments, the optomechanical components are disposed in a housing, and the monolithic structural element has the function of a carrier for the optomechanical components and the function of a housing part. In these and other embodiments, the monolithic structural element is precisely milled or cast from metal and, if necessary, reworked. In at least one embodiment, the monolithic structural element is made of plastic using an injection molding process. That plastic may further be fiber-reinforced.

In certain embodiments, the external coordinate system, and consequently the sensor positioning or setup, is aligned with high precision using mechanical means. The mechanical means may include one or more of positioning sleeves, centering pins, and abutment edges or the like.

In certain embodiments, an adjustment device which provides an absolute reference of the position of an illumination spot (x, y, z) for setup of the external coordinate system is provided for referencing the coordinate system of the transmitting optics to the external coordinate system. In these and other embodiments, after measuring the position of an illumination spot (x, y, z) in different and absolutely definable distances, the setup of a sensor or the external coordinate system is mechanically precisely reproduced.

### BRIEF DESCRIPTION OF THE FIGURES

With respect to the state of the art and preferred design examples of the teaching according to the invention, reference is made to the following figures. In connection with the discussion of preferred design examples of the invention on the basis of the figures, generally preferred configurations and further developments of the claimed teaching are discussed as well. In the drawing, the figures show

FIG. 1 in a schematic view, using the example of point triangulation, deviations of a real transmission axis of measurement systems from the ideal transmission axis according to the state of the art,

FIG. 2 in a schematic view, also using the example of point triangulation, the target region of the measurement application together with the positional deviation of the illumination spot,

FIG. 3 in a schematic view, the alignment according to the invention of an external mechanical reference coordinate system to the coordinate system of the measurement application,

FIG. 4 in a schematic view, the relationship between external and internal coordinate system together with the transmitting optics, and

FIG. 5 in a schematic view, the fusion of internal and external coordinate system, in particular the fusion of the outer housing part and the optomechanical carrier in the interior of the housing.

### DETAILED DESCRIPTION OF VARIOUS EMBODIMENTS

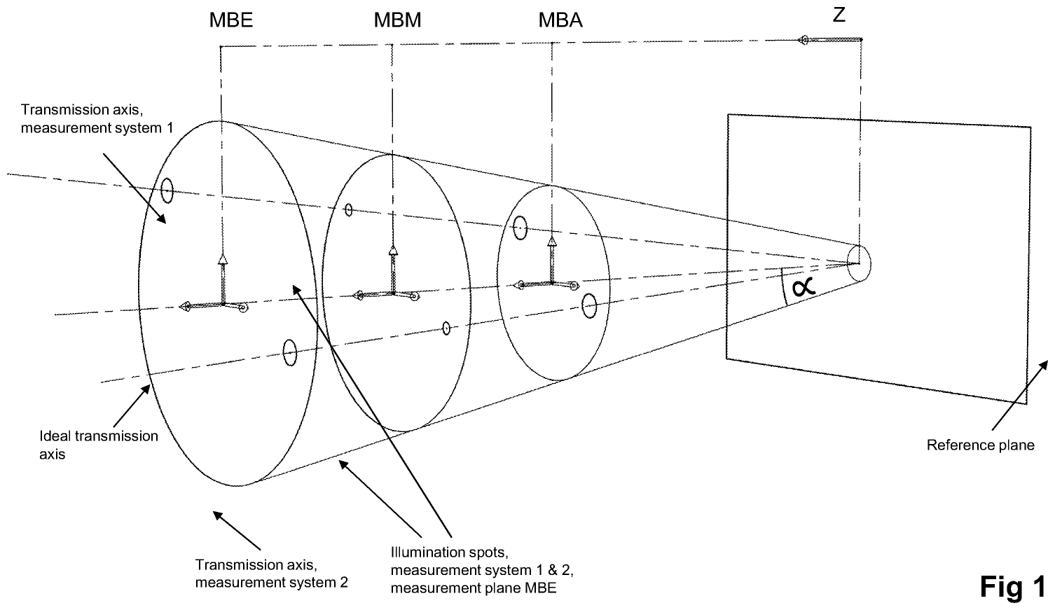

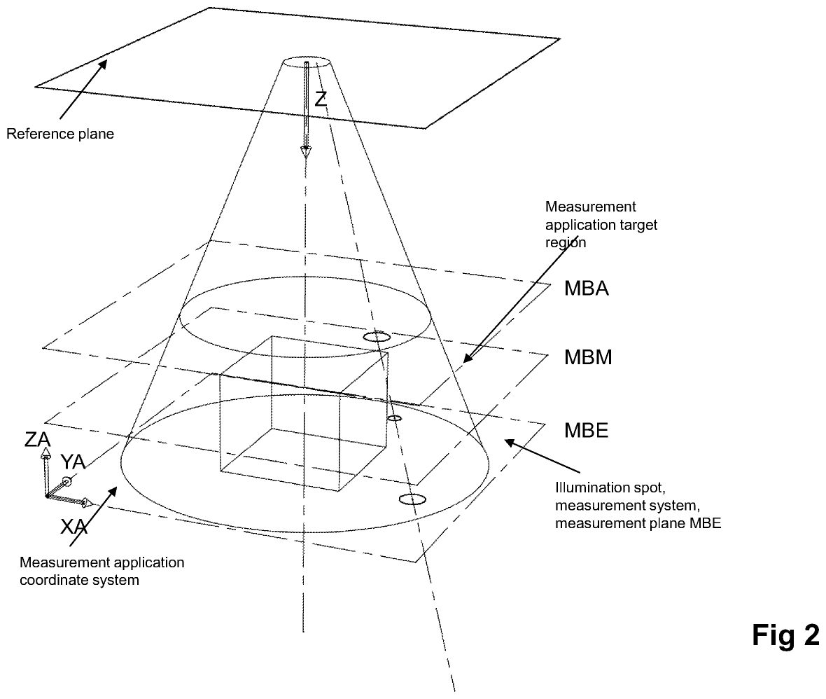

With respect to the state of the art, reference is made to FIG. 1, which shows deviations of real transmission axes from the ideal transmission axis using the example of point triangulation. FIG. 1 specifically shows deviations of a real transmission axis of measurement systems 1 and 2 and measurement planes through MBA (beginning of the measurement range), MBM (middle of the measurement range) and MBE (end of the measurement range). The figure shows a tolerance-afflicted truncated cone, which reveals the difficulty when measuring in the respective measurement plane. The position of the illumination spot needed for the measurement on the measurement object varies with the distance and/or when replacing the sensor with a sensor of the same type and, as shown in FIG. 2 using the example of point triangulation, often leads to leaving the target region required for the measurement application during the measurement. FIG. 2 shows the target region of the measurement application and the positional deviation of the illumination spot.

To date, the problem that occurs in the state of the art can only be solved individually for each measurement system, namely as follows:

In principle, optical alignment into the target region is possible, namely by means of a mechanical and/or electromechanical adjustment of the measurement system. The measurement system is always shifted, tilted or rotated. This can lead to a systematic distance error, namely if the measurement system is operated in a different setup than during the original calibration.

The measurement system can also be calibrated in a known coordinate system, for example in a coordinate measuring machine, according to which the target region is hit or reached by correcting the position of the respective measurement system. Such a calibration can, for example, be carried out using a standard, for example using a sphere, or by means of an optical measurement.

The measurement systems known from practice are disadvantageous with respect to the aforementioned problem, because, in order to avoid measurement errors, it is always necessary to carry out time-consuming calibrations/adjustments, specifically calibrations/adjustments beyond the adjustment during the original assembly. The respective transmission beam in particular causes problems in the measurement if there is even so much as a slight misalignment, because the exit point of the beam can then not be unambiguously defined.

The underlying object of the invention is therefore to optimize measurement systems for optical measurement in such a way that additional alignments and/or adjustments and/or calibrations by the user are not necessary.

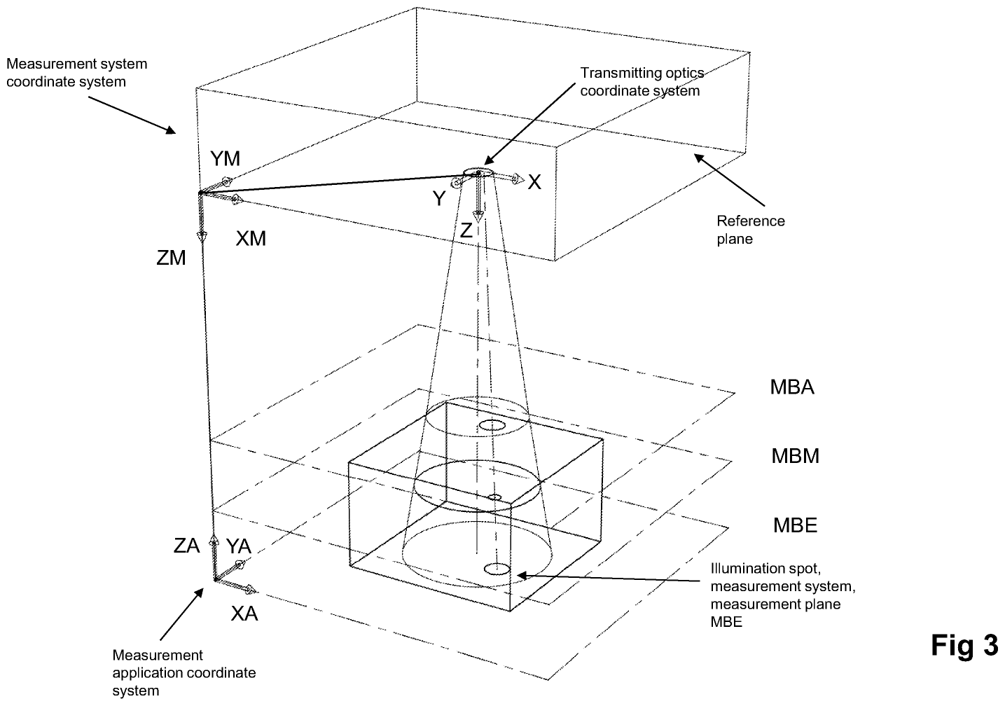

The measurement system according to the invention is intended to be aligned to the coordinate system of the measurement application only on its external mechanical reference coordinate system. The intent is for the measurement system to be constructed in such a way that the optical axis and/or the optical coordinate system has/have an unambiguous relationship to an external mechanical reference coordinate system. Due to this unambiguous relationship between the two coordinate systems, the tolerance-afflicted truncated cone can be minimized quite considerably in accordance with the explanations regarding FIGS. 1 and 2 in the majority of measurement applications, at least to such an extent that additional alignment and/or adjustment and/or calibration is unnecessary. FIG. 3 shows such an alignment of the external mechanical reference coordinate system to the coordinate system of the measurement application.

The underlying object of the invention is achieved by the features of the broadest claims accompanying herewith. The following definitions of terms are advantageous to better understand the invention:
1. The external mechanical reference coordinate system is the coordinate system of the measurement system. It is hereinafter also referred to as the external coordinate system.

It is the coordinate system that defines the sensor from the outside and has its reference point(s) on the housing of the sensor. It represents the coordinate system that the customer uses to precisely position and align the sensor. Within the framework of a simple configuration, screw points, fastening bores or fastening eyelets, reference edges or reference surfaces on the sensor are used for this purpose.
2. The transmitting optics coordinate system is the optical coordinate system. This is an initially virtual coordinate system that defines the position of the light beam. It is predominantly dependent on the optomechanical components (in relation to the light source, for example the laser, in relation to the imaging optics, for example the lenses, mirrors, lattices, etc., and in relation to the mechanics, for example the aperture, holder, connecting elements, etc.).
3. The receiving optics coordinate system is likewise initially a virtual coordinate system that defines the position of the detector. It is predominantly dependent on the optomechanical components (in relation to the receiver, for example, the CCD line, the CCD matrix, in relation to the imaging optics, for example the lenses, mirrors, lattices, etc., and in relation to the mechanics, for example the aperture, holder, connecting elements, etc.).
4. The internal coordinate system is a mechanical coordinate system inside the measurement system that serves as a reference for the optical axis.
5. The measurement application coordinate system is customer's coordinate system, in which the target region of the measurement application is located.

According to the teaching according to the invention, the measurement system used for optical measurement, in particular for measuring distance and/or position and/or speed and/or color, is provided with at least one external fixed point which defines an external coordinate system or at least lies therein. At least one internal fixed point is provided as well, which defines an internal coordinate system or at least lies therein. The two coordinate systems have an unambiguous position relative to one another, which implies an adjustment or calibration of the system. The key element of the teaching according to the invention is thus the unambiguous assignment of the two coordinate systems to one another. This unambiguous relationship between the two coordinate systems allows the previously discussed tolerance-afflicted truncated cone to largely be minimized, at least in such a way that additional alignment and/or adjustment and/or calibration of the system is unnecessary. In this respect, reference is again made to FIG. 3.

The two coordinate systems are particularly advantageously identical or congruent.

It is also conceivable that the two coordinate systems can be converted into one another by means of translation and/or rotation and/or mirroring.

The internal coordinate system defines the position of the optical components and/or the imaging components and/or the image-recording components.

The external coordinate system is to be understood as a mechanical reference coordinate system that has to be aligned with the coordinate system of the respective measurement application. The two coordinate systems have an unambiguous position relative to one another.

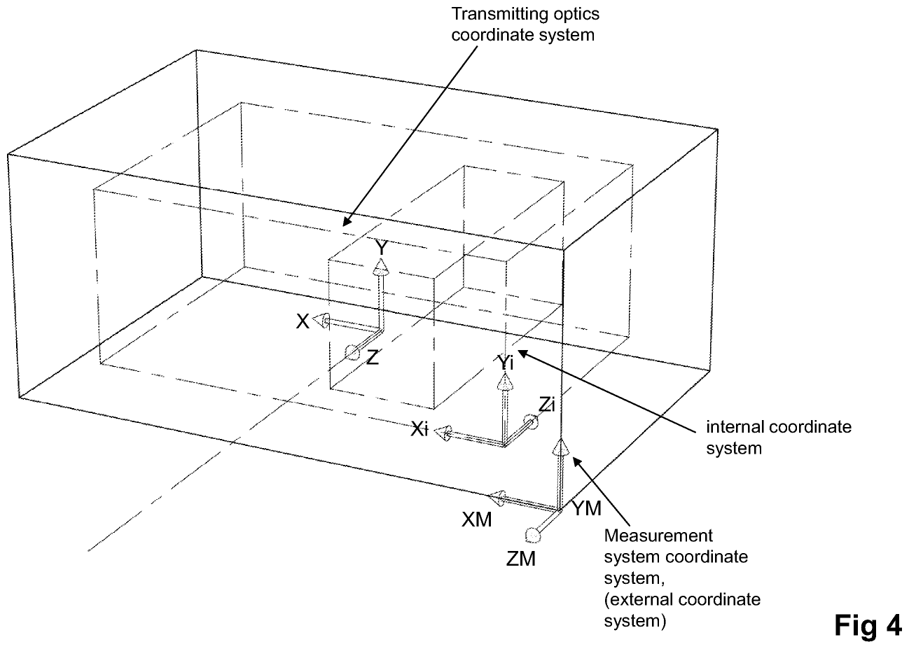

FIG. 4 shows the relationship between the external coordinate system, the internal coordinate system and the transmitting optics. An unambiguous position of the two coordinate systems relative to one another is the cornerstone of the system according to the invention.

The imaging components comprise at least one optomechanical light source as transmitting optics. The image-recording components comprise at least one optomechanical sensor element as receiving optics. The position of the optomechanical components or the transmitting optics relative to the internal coordinate system can be set to predeterminable values.

The mentioned external and the internal fixed point are assigned to a preferably monolithic structural element, a mono-block.

If the measurement system is a system for laser triangulation, it is advantageous if the transmitting optics and the receiving optics are disposed on the monolithic structural element adjusted in accordance with the fixed points. The monolithic structural element thus carries the transmitting optics and the receiving optics, which are aligned or adjusted relative to one another in a predeterminable relationship.

It is furthermore provided that the optomechanical components are disposed in a housing, namely that the essential components of the measurement system are located in a housing. In this case, the monolithic structural element has a double function. On the one hand, the monolithic structural element serves as a carrier for the optomechanical components. On the other hand, the monolithic structural element can be part of the housing. This benefits the unambiguous position of the coordinate systems relative to one another and simplifies the structure of the measurement system.

The monolithic structural element can be precisely milled or cast from metal and, if necessary, reworked. It is also conceivable that the monolithic structural element is made of plastic using an injection molding process, for example fiber-reinforced plastic. The monolithic structural element can also be produced using an additive process, for example by means of 3D printing.

The external coordinate system, and consequently the sensor positioning or setup, can be aligned using mechanical means. Positioning sleeves, centering pins, abutment edges, etc. are suitable for this purpose. These are simple means for positioning.

An adjustment device can be provided or used for referencing the coordinate system of the transmitting optics to the external coordinate system. Such an adjustment device provides an absolute reference of the position of an illumination spot (x, y, z) for setup of the external coordinate system.

Alternatively, after measuring the position of an illumination spot (x, y, z) in different and absolutely definable distances, the setup of a sensor or the external coordinate system can be mechanically precisely reproduced.

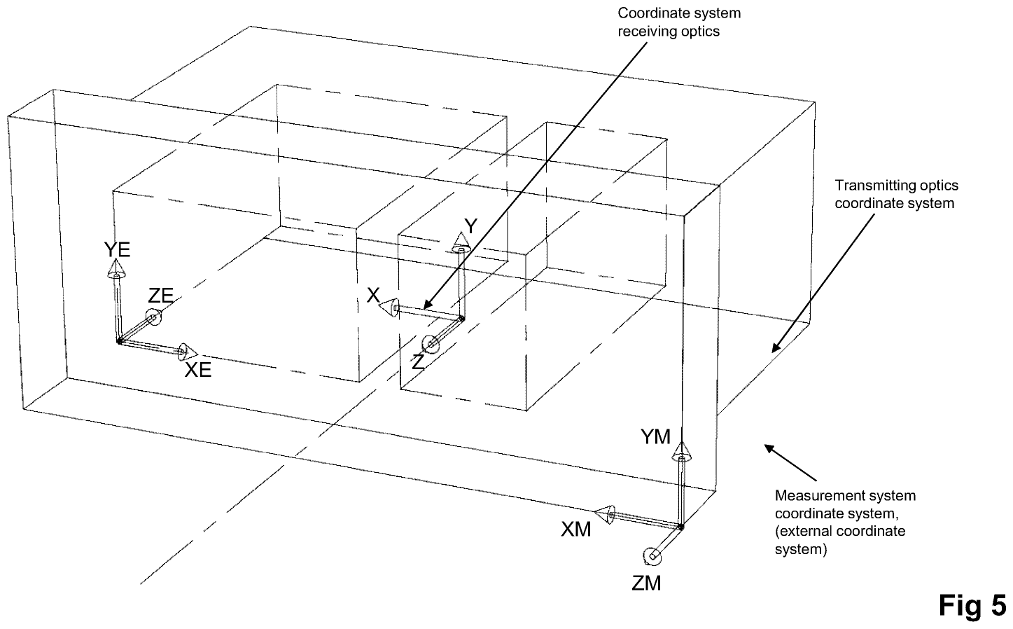

FIG. 5 schematically shows the fusion of the two coordinate systems, namely the internal and the external coordinate system. This is actually the fusion of the outer housing part and the optomechanical carrier in the interior of the housing. The essential factor in this context is that the sensor setup or the external coordinate system can be reproduced with absolute precision. This is achieved, for example, using positioning sleeves, centering pins, abutment edges, etc.

The previously discussed measurement system according to the invention has the enormous advantage that, in the majority of applications, it does not require any mounting position adjustment. This reduces the amount of maintenance required and makes the system user-friendly.

With respect to further advantageous configurations of the teaching according to the invention, reference is made to the general part of the description and to the attached claims in order to avoid repetitions.

Lastly, it must expressly be noted that the above described design examples of the teaching according to the invention serve only to explain the claimed teaching, but do not limit said teaching to these design examples.

1-16. (canceled)

17. Measurement system for optical measurement, in particular for measuring at least one of distance, position, speed, or color, the measurement system comprising:
at least one external fixed point, which defines an external coordinate system or lies therein, and
at least one internal fixed point, which defines an internal coordinate system or lies therein,
wherein the external and the internal coordinate systems have an unambiguous reproducible position relative to one another, which implies an adjustment or calibration of the system.

18. Measurement system according to claim 17, wherein the external and the internal coordinate systems are identical.

19. Measurement system according to claim 17, wherein the external and the internal coordinate systems can be converted into one another by means of at least one of translation, rotation, or mirroring.

20. Measurement system according to claim 17, wherein the internal coordinate system defines the position of at least one of the optical components, the imaging components, or the image-recording components.

21. Measurement system according to claim 20, wherein the internal coordinate system defines the position of the optical axis with respect to position and direction.

22. Measurement system according to claim 17, wherein the external coordinate system is a mechanical reference coordinate system that has to be aligned with the coordinate system of the respective measurement application.

23. Measurement system according to claim 17, wherein the imaging components comprise at least one optomechanical light source as transmitting optics.

24. Measurement system according to claim 17, wherein the image-recording components comprise at least one optomechanical sensor element as receiving optics.

25. Measurement system according to claim 17, wherein the position of the optomechanical components or the transmitting optics relative to the internal coordinate system can be set to predeterminable values.

26. Measurement system according to claim 17, wherein the external and the internal fixed point are assigned to a monolithic structural element.

27. Measurement system according to claim 17, further comprising transmitting optics and receiving optics disposed on a monolithic structural element adjusted in accordance with the fixed points.

28. Measurement system according to claim 27, wherein the transmitting optics and receiving optics are configured for laser triangulation.

29. Measurement system according to claim 27, wherein:
the optomechanical components are disposed in a housing, and
the monolithic structural element has the function of a carrier for the optomechanical components and the function of a housing part.

30. Measurement system according to claim 26, wherein the monolithic structural element is precisely milled or cast from metal and, if necessary, reworked.

31. Measurement system according to claim 26, wherein the monolithic structural element is made of plastic using an injection molding process.

32. Measurement system according to claim 31, wherein the plastic is fiber-reinforced plastic.

33. Measurement system according to claim 17, wherein the external coordinate system, and consequently the sensor positioning or setup, is aligned with high precision using mechanical means.

34. Measurement system according to claim 33, wherein the mechanical means are one of positioning sleeves, centering pins, and abutment edges.

35. Measurement system according to claim 17, wherein an adjustment device which provides an absolute reference of the position of an illumination spot (x, y, z) for setup of the external coordinate system is provided for referencing the coordinate system of the transmitting optics to the external coordinate system.

36. Measurement system according to claim 17, wherein, after measuring the position of an illumination spot (x, y, z) in different and absolutely definable distances, the setup of a sensor or the external coordinate system is mechanically precisely reproduced.
